(19) United States
(12) Patent Application Publication
(10) Pub. No.: US 2011/0292386 A1
(43) Pub. Date: Dec. 1, 2011

(54) SPECTRAL MEASUREMENT DEVICE

(75) Inventor: Tatsuaki FUNAMOTO, Shiojiri (JP)

(73) Assignee: SEIKO EPSON CORPORATION, Tokyo (JP)

(21) Appl. No.: 13/112,316

(22) Filed: May 20, 2011

(30) Foreign Application Priority Data
Jun. 1, 2010 (JP) 2010-125717

(51) Int. Cl. G01J 3/42

(52) U.S. Cl. 356/319

(57) ABSTRACT

A spectral measurement device includes an optical band-pass filter section having a spectral band of first to n-th wavelengths (n is an integer of 2 or more), a light receiving section, a correction operation section, and a signal processing section. When an m-th wavelength band (1≦m≦n) is an interest wavelength band, and a k-th wavelength band (k≠m and 1≦k≦n) other than the m-th wavelength band is a non-interest wavelength band, the optical band-pass filter section functions as a m-th band-pass filter corresponding to the m-th wavelength band and a k-th band-pass filter corresponding to the k-th wavelength band.

### BACKGROUND

1. Technical Field

The present invention relates to spectral measurement devices.

2. Related Art

Examples of a spectral measurement device include a colorimeter, a spectroscopic analyzer, and a spectrum analyzer. JP-A-2002-277326 discloses a spectral measurement device that uses a transmission wavelength-variable filter. Moreover, JP-A-5-248952 discloses an optical spectrum analyzer that uses an etalon spectrometer (Fabry-Perot etalon filter) as a spectrometer capable of variably controlling transmission wavelengths.

For example, when a half bandwidth of an optical band-pass filter used as a spectrometer is broad, light of wavelengths other than a desired wavelength band is mixed into the transmission light (or reflection light) of the optical band-pass filter. Here, the half bandwidth represents a bandwidth of a wavelength at which a relative spectral intensity is 50% of the peak value. In this case, a noise component corresponding to the light of wavelengths other than a desired band is included in a reception signal obtained by a light receiving section (for example, a photodiode and an image sensor) receiving signals from the optical band-pass filter. Therefore, in a spectral measurement device using band-pass filters, usually, a certain level of accuracy is secured by obtaining high-accuracy light intensity data using a plurality of high-accuracy filters in accordance with a measurement wavelength band.

By using a configuration (for example, a configuration having between 10 and 20 expensive fixed interference filters and photoreceivers) having a high-performance optical band-pass filter with excellent wavelength separation properties, it is possible to suppress noise components. However, a high-performance optical band-pass filter is generally expensive and large. Therefore, for example, when reducing the costs and size of the spectral measurement device is prioritized, it is difficult to use the high-performance optical band-pass filters.

If there is no choice but to use high-performance special filters, it is not possible to use high-performance variable wavelength filters. A variable wavelength filter is one type of filter device and is an optical filter capable of realizing a plurality of filter properties. Since the variable wavelength filter can cover a plurality of wavelength bands using the same filter, it is effective for miniaturization and cost reduction of an optical filter and has excellent usability. However, the variable wavelength filter generally does not have excellent wavelength separation properties. Therefore, due to the inferior wavelength separation properties (wavelength resolution), it is difficult to realize miniaturization and cost reduction of a spectral measurement device which uses a variable wavelength filter.

### SUMMARY

An advantage of some aspects of the invention is that it provides a spectral measurement device capable of improving measurement accuracy without using an expensive optical band-pass filter, for example.

(1) According to an aspect of the invention, there is provided a spectral measurement device including: an optical band-pass filter section that has first to n-th wavelengths (n is an integer of 2 or more) having a predetermined wavelength width as a spectral band thereof; a light receiving section that receives light from the optical band-pass filter section; a correction operation section that performs an operation to correct a reception signal obtained from the light receiving section; and a signal processing section that executes predetermined signal processing based on the reception signal corrected by the correction operation section, wherein when, among the first to n-th wavelengths, an m-th wavelength band (1≦m≦n) is an interest wavelength band, and a k-th wavelength band (k≠m and 1≦k≦n) other than the m-th wavelength band is a non-interest wavelength band, the optical band-pass filter section functions as an m-th band-pass filter corresponding to the m-th wavelength band and also functions as a k-th band-pass filter corresponding to the k-th wavelength band, and wherein the correction operation section includes a noise estimation section that estimates the amount of the noise component for each wavelength band of the k-th wavelength band included in an interest reception signal obtained by the light receiving section receiving transmission light or reflection light of the m-th band-pass filter corresponding to the m-th wavelength band, and a noise removal and correction section that performs correction of subtracting the sum of the estimated noise component for each wavelength band from the interest reception signal to thereby calculate a corrected reception signal.

In this aspect of the invention, an optical band-pass filter section is used as a spectrometer (optical filter). The optical band-pass filter section functions as a m-th band-pass filter corresponding to an m-th wavelength band (1≦m≦n) which is an interest wavelength band and a k-th band-pass filter corresponding to a k-th wavelength band (k≠m and 1≦k≦n) which is a non-interest wavelength band.

The transmission light or reflection light of the m-th band-pass filter includes light of the interest wavelength band and light of the non-interest wavelength band. Therefore, when light from the m-th band-pass filter is received by the light receiving section (photodiodes, optical sensors, and the like), noise components are included in all of the reception signals. The amount of the noise components (the reception signal components corresponding to the light of the non-interest wavelength band) is smaller than the amount of the reception signal components (normal reception signal components) of the interest wavelength band. However, for example, when there are a number of non-interest wavelength bands, the total amount of the noise components may not be negligible if the noise components of the respective bands were summed. Moreover, for example, depending on the reflectance (transmittance) of a sample, a large amount of noise may appear in a specific wavelength band.

Therefore, in this aspect of the invention, through signal processing (correction processing of reception data), the sum of the noise component for each wavelength band included in all of the reception signals (that is, interest reception signals) obtained by receiving light from the m-th band-pass filter is obtained, and the calculated sum of noise components is subtracted from all of the reception signals to thereby suppress the effect of noise.

That is, the spectral measurement device of this aspect of the invention includes a correction operation section, and the correction operation section includes a noise estimation section and a noise removal and correction section. The noise estimation section estimates the amount of the noise component for each wavelength band of the k-th wavelength band included in an interest reception signal obtained by the light receiving section receiving transmission light or reflection light of the m-th band-pass filter corresponding to the m-th wavelength band. Moreover, the noise removal and correction section performs correction of subtracting the sum of the estimated noise component for each wavelength band from the interest reception signal to thereby calculate a corrected reception signal.

According to this aspect of the invention, it is possible to improve the accuracy of the spectroscopic data (optical spectrum data) through correction of the reception data and to thereby improve the measurement accuracy of the spectral measurement device. For example, although the optical spectrum data obtained using an optical filter having a low wavelength separation performance generally have low accuracy, according to this aspect of the invention, since the data accuracy can be improved through signal processing, it is possible to use various optical filters (for example, optical filters which are small and cheap and are easy to use). Since the range of choice in optical filters broadens, it is possible to realize a spectral measurement device which is small, light, and cheap, and has high measurement accuracy, and which, for example, uses variable wavelength filters having high performance or cheaper optical filters.

As a transmission-type optical band-pass filter, an etalon filter can be used, for example, and as a reflection-type optical band-pass filter, a dichroic mirror can be used, for example. The first to n-th optical band-pass filters corresponding to the respective wavelength bands may be realized using a variable wavelength filter and may be realized by juxtaposing a plurality (n) of fixed wavelength filters having different wavelength bands.

(2) According to another aspect of the spectral measurement device of the invention, when the interest reception signal obtained by the light receiving section receiving the transmission light or reflection light of the m-th band-pass filter is Sm, a non-interest reception signal obtained by the light receiving section receiving the transmission light or reflection light of the k-th band-pass filter is Sk, a transmittance or a reflectance in the k-th wavelength band of the m-th band-pass filter is P(m,k), a transmittance or a reflectance in the k-th wavelength band of the k-th band-pass filter is P(k,k), and a noise component for each wavelength band of the k-th wavelength band included in the interest reception signal Sm is N(m,k), the noise estimation section performs an operation based on Formula (1) (N(m,k)=Sk·{P(m,k)/P(k,k)} . . . (1)) to estimate the amount of the noise component for each wavelength band of the k-th wavelength band included in the interest reception signal Sm, and the noise removal and correction section calculates the sum ΣN(m,k) of the estimated noise component N(m,k) for each wavelength band and executes an operation based on Formula (2) (Smc=Sm−ΣN(m,k) . . . (2)) to obtain the corrected reception signal Smc.

In this aspect of the invention, the noise estimation section estimates the amount of the noise component for each wavelength band in the non-interest wavelength band through the operation based on Formula (1). Moreover, the noise removal and correction section calculates the sum of the estimated noise components for each wavelength band and calculates the corrected interest reception signal (that is, corrected reception signal) through the operation based on Formula (2).

In Formula (1) above (that is, N(m,k)=Sk·{P(m,k)/P(k,k)}), Sk is the non-interest reception signals obtained by the light receiving section receiving the transmission light or the reflection light of the k-th band-pass filter. The non-interest reception signals are all of the reception signals which are the entire output of the photodiodes and are known since they are actually measured. Here, although it is ideal to use only the value of a reception signal corresponding to light of the k-th wavelength band among the non-interest reception signals, since it is not possible to separate only the reception component corresponding to the light of the k-th wavelength band, all of the reception signals of the k-th band-pass filter are used as a substitute.

Moreover, P(m,k) is the transmittance or the reflectance in the k-th wavelength band of the m-th band-pass filter. The notation P(m,k) represents the transmittance (or the reflectance) P in the “k”-th wavelength band which is the non-interest wavelength band, of the “m”-th band-pass filter (an optical filter associated to the “m”-th wavelength band which is the interest wavelength). Moreover, the spectral properties (relative spectral intensities of the respective wavelengths) in all of the wavelength bands of the m-th band-pass filter are known. Moreover, for example, P(m,k) can be calculated by integrating the transmittance (reflectance) of the respective wavelengths included in the k-th wavelength band (that is, by calculating all of the area of the k-th wavelength band in a graph showing the relationship between wavelengths and transmittance (reflectance)). Therefore, P(m,k) is known.

Moreover, P(k,k) is the transmittance or the reflectance in the k-th wavelength band of the k-th band-pass filter. The notation P(k,k) represents the transmittance (or the reflectance) P in the “k”-th wavelength band which is the non-interest wavelength band, of the “k”-th band-pass filter (an optical filter associated to the “k”-th wavelength band which is the non-interest wavelength). Moreover, since the k-th band-pass filter is a filter associated to the k-th wavelength band, the transmittance in the k-th wavelength band is known.

The interest reception signal Sm is calculated using these known values. That is, the noise components N(m,k) for each wavelength band of the k-th wavelength band included in all of the reception signals obtained by the light receiving section receiving light from the m-th band-pass filter which is a filter associated to the interest wavelength band are calculated. The use of the expression “noise components N(m,k) for each wavelength band of the k-th wavelength band” is based on the following reason. As described above, the first to n-th wavelength bands are wavelength bands each having a predetermined wavelength width, and if n≧3, there will be two or more k-th wavelength bands which are the non-interest wavelength bands. Considering this, the expression clearly expresses a case in which when there is a plurality of wavelength bands as the non-interest wavelength bands, the noise components for each wavelength band are calculated.

Here, it is possible to obtain the reception signal Sk corresponding to the transmittance (reflectance) P(k,k) in the k-th wavelength band of the k-th band-pass filter. That is, all of the reception signals can be as a substitute by regarded them as the reception signal corresponding to the k-th wavelength band. If P(k,k) is changed to P(m,k), since the amount of reception signals changes in accordance with the ratio between P(k,k) and P(m,k), the amount of reception signals will be changed to Sk·{P(m,k)/P(k,k)}. In this aspect of the invention, this amount of reception signal is regarded as the noise components N(m,k) for each wavelength band of the k-th wavelength band included in the interest reception signal Sm. Formula (1) above expresses this.

In this way, when the noise components are calculated for each non-interest wavelength band, the noise removal and correction section calculates the sum ΣN(m,k) of the estimated noise components N(m,k) for each wavelength band. The notation ΣN(m,k) represents all of the signal components (that is, all of the noise components ΣN) of the “k”-th wavelength band which is the non-interest wavelength band, included in all of the reception signals obtained by the light receiving section receiving light from the “m”-th band-pass filter which is a filter associated to the interest wavelength band.

Moreover, the noise removal and correction section executes an operation based on Formula (2) (namely, Smc=Sm−ΣN(m,k)) to obtain the corrected reception signal Smc. The corrected reception signal Smc is obtained by removing noise therefrom and can be regarded as substantially the reception signal (reception data) corresponding to light of the interest wavelength band. Thus, the measurement accuracy of the optical spectrum data is improved.

(3) According to still another aspect of the spectral measurement device of the invention, when the sum of transmittance or reflectance of entire wavelength bands of the m-th band-pass filter is ΣQm(1˜n), the sum of transmittance or reflectance of all of the wavelength bands of the k-th band-pass filter is ΣQk(1˜n), and a correction coefficient for correcting a difference in the transmittance properties or reflectance properties between filters is R (=ΣQm(1˜n)/Qk(1˜n)), the noise estimation section performs an operation based on Formula (3) (N(m,k)=Sk·{P(m,k)/P(k,k)}·R . . . (3)) to estimate the amount of the noise component for each wavelength band of the k-th wavelength band included in the interest reception signal Sm.

In this aspect of the invention, the accuracy of noise estimation is further increased. In this aspect of the invention, when calculating the noise components, Formula (3) is used in place of Formula (1) described above.

In the aspect of the invention (2) described above, noise components are calculated based on a way of thinking in which “if P(k,k) is changed to P(m,k), since the amount of reception signals changes in accordance with the ratio between P(k,k) and P(m,k), the amount of reception signals will be changed to Sk·{P(m,k)/P(k,k)}”. However, actually, when an optical filter being used is switched from the k-th band-pass filter to the m-th band-pass filter, there is a difference in the total amount (total light intensity) of light entering the light receiving section after passing through the respective filters due to the different properties (for example, relative transmittance distribution or relative reflectance distribution) of the respective filters.

As described above, Sk used in Formula (1) above represents all of the reception signals of the light receiving section when the k-th band-pass filter is used. The noise components that are to be calculated are noise components included in all of the reception signals of the light receiving section when the m-th band-pass filter is used. That is, the noise components included in all of the reception signals when the m-th band-pass filter is used are estimated using actual measurement values when the k-th band-pass filter (a filter different from the m-th band-pass filter associated to correction) is used. At that time, there is a difference in the total amount (total light intensity) of light entering the light receiving section after passing through the respective filters due to the different properties (for example, relative transmittance distribution or relative reflectance distribution) of the respective filters. Therefore, by adding signal processing for compensating for the difference in the total light intensity resulting from the different properties of the respective filters when estimating noise, it is possible to further improve the measurement accuracy of the optical spectrum data.

Therefore, in this aspect of the invention, the operational formula of Formula (1) above is multiplied by the correction coefficient R for correcting the difference in the transmittance property or the reflectance property between filters (that is, the operation based on Formula (3) above is executed).

Here, the sum of the transmittance or the reflectance of all of the wavelength bands of the m-th band-pass filter is denoted as ΣQm(1˜n), and the sum of the transmittance or the reflectance of all of the wavelength bands of the k-th band-pass filter is denoted as ΣQk(1˜n). When the k-th band-pass filter is switched to the m-th band-pass filter, the total amount of light entering the light receiving section will change in accordance with ΣQm(1˜n)/Qk(1˜n). Therefore, all of the reception signals Sk obtained from the light receiving section when the k-th band-pass filter is used will be corrected as Sk·{ΣQm(1˜n)/ΣQk(1˜n)} when the m-th band-pass filter is used.

The ratio (ΣQm(1˜n)/ΣQk(1˜n)) of the sum of transmittance properties and reflectance properties between the respective filters will be referred to as the correction coefficient R for correcting (compensating for) the difference in the transmittance properties or the reflectance properties between the respective filters. By multiplying the operational formula of Formula (1) above by the correction coefficient R, the difference in the transmittance properties or the reflectance properties between the respective filters is compensated for. Accordingly, the measurement accuracy of the optical spectrum data is improved further.

(4) According to yet another aspect of the spectral measurement device of the invention, the optical band-pass filter section is formed of a variable wavelength filter, and the properties of the variable wavelength filter are variably controlled whereby the band-pass properties of the m-th band-pass filter and the k-th band-pass filter are realized.

The variable wavelength filter is one type of filter device and is a high-performance optical filter capable of realizing a plurality of filter properties. Since the variable wavelength filter can cover a plurality of wavelength bands using the same filter, it is effective for miniaturization and cost reduction of an optical filter and has excellent usability. Although the variable wavelength filter generally does not have excellent wavelength separation properties, as described above, the measurement accuracy can be improved through correction of the reception data. Therefore, it is possible to realize a spectral measurement device which is small, light, and cheap, and has high measurement accuracy, for example, by using variable wavelength filters having high performance.

(5) According to still yet another aspect of the spectral measurement device of the invention, the optical band-pass filter section is a variable gap-type etalon filter.

The variable gap-type etalon filter (hereinafter referred to as a variable-gap etalon filter) is a wavelength-variable filter which uses the principle of a Fabry-Perot interferometer, and which has a simple configuration and is suitable for miniaturization and cost reduction. Therefore, it is possible to realize a spectral measurement device which is small, light, and cheap, and has high measurement accuracy, for example, by using the variable-gap etalon filter.

(6) According to further another aspect of the spectral measurement device of the invention, the signal processing section measures a spectrophotometric distribution of the sample based on the corrected reception signal.

Through measurement of the spectrophotometric distribution, it is possible to measure the color of a sample and analyze the composition of a sample, for example.

### BRIEF DESCRIPTION OF THE DRAWINGS

The invention will be described with reference to the accompanying drawings, wherein like numbers reference like elements.

FIG. 1 is a diagram showing an example of a configuration of a spectral measurement device.

FIGS. 2A and 2B are diagrams showing a configuration example of a variable-gap etalon and an example of band-pass filter properties, respectively.

FIG. 3 is a diagram showing an example of a configuration of a rotary band-pass filter used as an optical band-pass filter.

FIG. 4 is a diagram illustrating a configuration example of a correction calculation section and an outline of correction calculation.

FIGS. 5A and 5B are diagrams showing an example of a measurement procedure when the surface color of a sample is measured by a colorimeter (color measurement device).

FIGS. 6A to 6C are diagrams showing an example of a spectral property of an optical band-pass filter, a reflectance property of a sample (red), and reception signal intensities in respective photodiodes, respectively.

FIG. 7 is a diagram showing a difference between a spectral reflectance curve of a sample (red) and spectral reflectance values based on measured 16-point data (data which are not subjected to correction processing according to the invention).

FIGS. 8A and 8B are diagrams showing the distribution of reception signal intensities (relative reception signal intensities) of respective photodiodes and showing the extracted optical spectra of a reception signal in a third wavelength band (a wavelength band having a central wavelength of 440 nm) in an enlarged scale, respectively.

FIG. 9 is a diagram showing, for comparison purpose, a spectral reflectance curve generated based on measurement data (16-point data) before correction and a spectral reflectance curve generated based on measurement data (16-point data) after correction.

FIGS. 10A and 10B are diagrams illustrating an outline of an estimation method of noise components in a 13-th wavelength band, which are included in the light of a third wavelength band passed through a third band-pass filter.

FIGS. 11A to 11D are diagrams showing a first specific example (correction using Operational Formula (1)) of a method of estimating the amount of the noise components.

FIGS. 12A to 12C are diagrams showing a second specific example (correction using Operational Formula (3)) of a method of estimating the amount of the noise components.

FIGS. 13A to 13C are diagrams illustrating the content of noise removal and correction by a noise removal and correction section.

FIGS. 14A to 14C are diagrams showing an example of a method of calculating the sum of noise components.

FIGS. 15A and 15B are diagrams showing a difference in the band-pass filter properties depending on the presence of correction processing.

### DESCRIPTION OF EXEMPLARY EMBODIMENTS

Hereinafter, embodiments of the invention will be described with reference to the drawings. It should be noted that the embodiment described below do not disadvantageously restrict the content of the invention described in the scope of the claims and not all of the constructions described with reference to the following embodiments are necessary as solving means of the invention.

### First Embodiment

First, an overall configuration of a spectral measurement device (for example, a colorimeter, a spectroscopic analyzer, and an optical spectrum analyzer) will be described.

### Example of Overall Configuration of Spectral Measurement Device

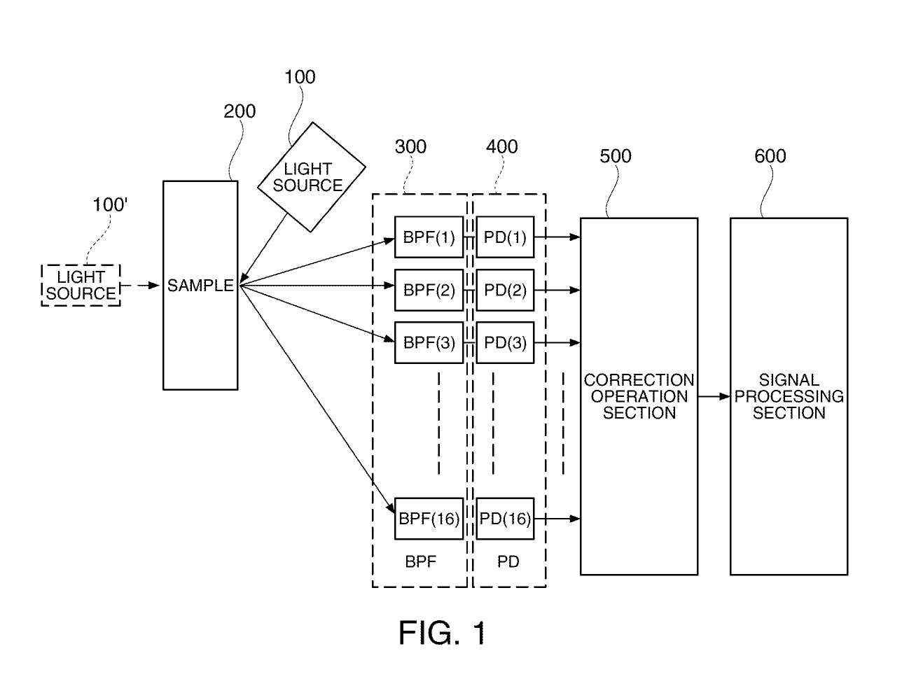

FIG. 1 is a diagram showing an example of a configuration of a spectral measurement device. Examples of a spectral measurement device include a colorimeter, a spectroscopic analyzer, and a spectrum analyzer. For example, a light source 100 is used when performing color measurement of a sample 200, and a light source 100′ is used when performing spectroscopic analysis of the sample 200.

The spectral measurement device includes the light source 100 (or 100′), an optical band-pass filter section (BPF) 300, a light receiving section (PD) 400 using photodiodes and the like, a correction operation section 500 that performs a correction operation (correction processing) for correcting a reception signal (light intensity data) obtained from the light receiving section 400, and a signal processing section 600 that calculates a spectrophotometric distribution and the like based on the light intensity data (reception data) after correction. As the light source 100 (100′), an incandescent bulb, a fluorescent bulb, a discharge tube, a light source (a solid-state lighting source) using a solid-state light emitting element such as an LED, and the like can be used.

The optical band-pass filter section (BPF) 300 functions as a spectrometer and has first to n-th wavelength bands having a predetermined wavelength width as the spectral band thereof (n is an integer of 2 or more, and in the example of FIG. 1, n=16). In the following description, among the first to n-th wavelength bands, an m-th wavelength band (1≦m≦n) is sometimes referred to as an interest wavelength band, and a k-th wavelength band (k≠m and 1≦k≦n) other than the m-th wavelength band is sometimes referred to as a non-interest wavelength band.

The optical band-pass filter section (BPF) 300 functions as an m-th band-pass filter corresponding to the m-th wavelength band and also functions as a k-th band-pass filter corresponding to the k-th wavelength band. Specifically, the optical band-pass filter section 300 may be a transmission-type optical band-pass filter and may be a reflection-type optical band-pass filter. As the transmission-type optical band-pass filter, a variable-gap etalon filter can be used, for example. As the reflection-type optical band-pass filter, a dichroic mirror (or a dichroic prism), a diffraction grating, and the like can be used, for example. The dichroic mirror is one type of mirror formed of a special optical material, and is an optical filter having a property such that it reflects light of a specific wavelength and transmits light of other wavelengths.

The optical band-pass filter (BPF) 300 of the present embodiment has n spectral bands (n is an integer of 2 or more, and in the example of FIG. 1, n=16), and the wavelength width of the respective spectral bands is set to 20 nm, for example. In FIG. 1, for the sake of convenience, 16 band-pass filters (that is, the first band-pass filter BPF(1) to the 16th band-pass filter BPF(16)) corresponding to the respective 16 spectral bands are illustrated. The respective band-pass filters BPF(1) to BPF(16) have a property such that they transmit (or reflect) at least light of a specific wavelength.

The first to 16th optical band-pass filters BPF(1) to BPF(16) corresponding to the respective wavelength bands may be realized using one or plural variable wavelength filters and may be realized by arranging (juxtaposing) 16 fixed wavelength filters having different wavelength bands.

The central wavelengths of the spectral bands associated to the first to 16th band-pass filters BPF(1) to BPF(16) are λ1 to λ16. For example, the central wavelengths are set such that λ1=400 nm, λ2=420 nm, λ3=440 nm, λ4=460 nm, λ5=480 nm, λ6=500 nm, λ7=520 nm, λ8=540 nm, λ9=560 nm, 10=580 nm, λ11=600 nm, λ12=620 nm, λ13=640 nm, λ14=660 nm, λ15=680 nm, and λ16=700 nm.

The light receiving section (PD) 400 that receives light from the optical band-pass filter section 300 includes 16 photodiodes (that is, the first photodiode PD(1) to the 16th photodiode PD(16)). The respective photodiodes PD(1) to PD(16) have reception sensitivity to the above-mentioned respective wavelength bands. When it is possible to use optical sensors having a broad wavelength band to which they have reception sensitivity, one or plural optical sensors may be used.

The correction operation section 500 suppresses an increase of noise (a decrease of measurement accuracy) resulting from substantially broad transmission wavelength bands (reflection wavelength bands) of the 16 band-pass filters (the first to 16th band-pass filters BPF(1) to BPF(16)) by a correction operation using the other wavelength bands (non-interest wavelength bands) other than a target wavelength band (interest wavelength band).

For example, when an optical band-pass filter having a simple configuration such as a variable-gap etalon filter is used as the optical band-pass filter 300, it is possible to realize the spectral measurement device with a simple and miniaturized configuration at a low cost. However, in that case, since the optical band-pass filter (wavelength band-pass filter) has a broad wavelength transmission property and thus transmits light of wavelengths other than an intended wavelength band, noise components (errors) are superimposed on the reception signal.

For example, although the first band-pass filter BPF(1) is designed to transmit light having wavelengths in the λ1 wavelength band, if the wavelength separation property is not sufficiently high, it transmits light of wavelengths in all wavelength bands, for example, including λ2 to λ16. Such a phenomenon also occurs in the second to 16th band-pass filters BPF(2) to BPF(16).

In this case, for example, a reception signal S corresponding to the first band-pass filter BPF(1) includes a noise component (Σ{S(λ2)˜S(λ16)}) as well as an intended reception signal (S(λ1): a normal reception signal) of the wavelength λ1. Therefore, the value of the reception signal S corresponding to the first wavelength band (central wavelength: λ1) increases by an amount corresponding to the noise component (that is, base floating occurs), which causes measurement errors.

Although the amount of the noise components is small as compared to the amount of normal signal components, noise is included in each signal of the respective wavelength bands. For example, depending on the reflectance (transmittance) of the sample 200, a large amount of noise may appear in a specific wavelength band. Therefore, it is necessary to perform correction operation processing in order to suppress errors as much as possible.

For example, if the amounts of the reception signals of the non-interest wavelength bands (λ2 to λ16) in the first band-pass filter BPF(1) are substantially uniform, a method of subtracting a predetermined amount (the noise components resulting from the wavelengths λ2 to λ16) from all of the reception signal corresponding to the first band-pass filter BPF(1) can be considered. However, actually, the amounts of reception signals corresponding to the respective wavelengths λ2 to λ16 change in accordance with the reflectance (transmittance) of the sample 200. Since the reflectance (transmittance) of the sample 200 is unknown, the amounts of reception signals (amounts of noise components) of the respective wavelengths λ2 to λ16 are not clear. Thus, such a rapid method may not be used.

Therefore, a new base floating correction processing in which noise components are estimated, and the estimated noise components are subtracted from a normal reception signal (light intensity data) is required. Therefore, the correction operation section 500 estimates the amounts of the noise components for each wavelength band of the k-th wavelength band included in the interest reception signal obtained by the light receiving section 300 receiving the transmission light or the reflection light of the m-th band-pass filter corresponding to the m-th wavelength band. Then, the correction operation section 500 performs correction of subtracting the sum of the estimated amounts of the noise components for each wavelength band from the interest reception signal to calculate a corrected reception signal. The detailed content of this correction processing will be described later.

The correction operation section 500 executes the correction operation for suppressing base floating as described above and supplies the corrected light intensity data (the corrected reception signal) to the signal processing section 600. The signal processing section 600 executes predetermined signal processing using the corrected light intensity data (the corrected reception signal) to calculate a spectrophotometric distribution. Moreover, the signal processing section 600 generates a curve or the like representing the spectral distribution, for example.

According to the spectral measurement device having the configuration of FIG. 1, it is possible to improve the accuracy of spectroscopic data (optical spectrum data) by correcting the reception data. Therefore, the measurement accuracy of the spectral measurement device is improved. For example, although the optical spectrum data obtained using an optical filter having low wavelength separation performance generally have low accuracy, since the data accuracy can be improved through signal processing, it is possible to use various optical filters (for example, optical filters which are small and cheap and are easy to use). Since the range of choice in optical filters broadens, it is possible to realize a spectral measurement device which is small, light, and cheap, and has high measurement accuracy, and which, for example, uses variable wavelength filters having high performance or cheaper optical filters.

### Specific Example of Configuration of Optical Band-Pass Filter Section

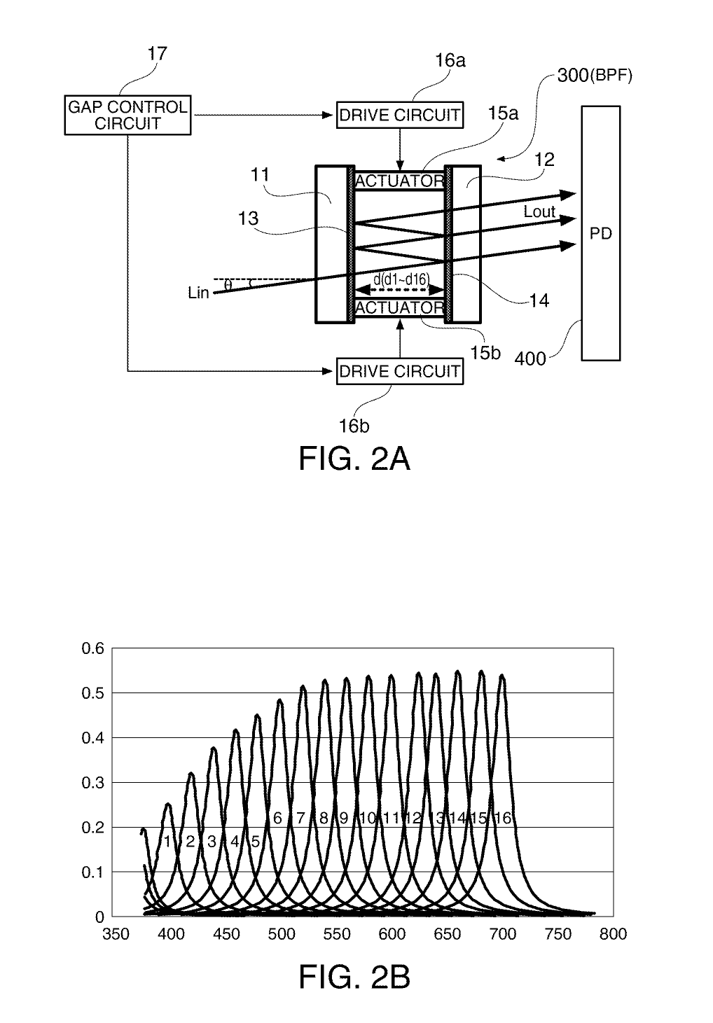

FIGS. 2A and 2B are diagrams showing a configuration example of a variable-gap etalon and an example of band-pass filter properties, respectively. As shown in FIG. 2A, a variable-gap etalon filter includes a first substrate 11 and a second substrate 12 disposed to face each other, a first reflection film 13 formed on the principal surface (front surface) of the first substrate 11, a second reflection film 14 formed on the principal surface (front surface) of the second substrate 12, and a first actuator (for example, a piezoelectric element or the like) 15a and a second actuator 15b which are interposed between the respective substrates so as to adjust a gap (distance) between the respective substrates.

The first and second actuators 15a and 15b are driven by a first drive circuit 16a and a second drive circuit 16b, respectively. Moreover, the operation of the first and second drive circuits 16a and 16b is controlled by a gap control circuit 17.

Light Lin incident from the outside at a predetermined angle θ passes through the first reflection film 13 substantially without being scattered. The reflection of light occurs repeatedly between the first reflection film 13 formed on the first substrate 11 and the second reflection film 14 formed on the second substrate 12. In this way, interference of light occurs, and part of the incident light passes through the second reflection film 14 on the second substrate 12 and enters the light receiving section 400 (the photodiode PD). Which wavelength of light will be strengthened by the interference depends on the gap between the first substrate 11 and the second substrate 12. Therefore, it is possible to change the wavelength band of light passing through the second reflection film 14 by controlling the gap variably.

FIG. 2B shows a spectral property of the variable-gap etalon filter (specifically, a relative spectral intensity for each of 16 wavelength bands each having a width of 20 nm). When a variable-gap etalon filter is used as the optical band-pass filter section (spectrometer section) 300, since a plurality of transmission wavelength bands can be realized using one filter, it is possible to obtain a spectrometer section which is simple, small, and cheap.

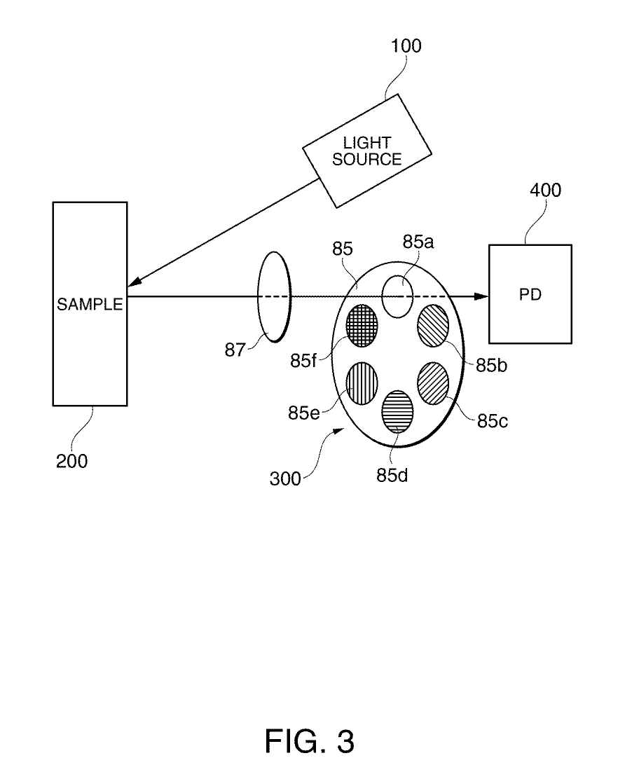

FIG. 3 is a diagram showing an example of a configuration of a rotary band-pass filter used as an optical band-pass filter. A rotary band-pass filter includes an optical system (lens) 87 and a rotatable disk 85 in which a plurality of band-pass filters 85a to 85f having different transmission wavelength bands is incorporated. One of the band-pass filters 85a to 85f is selected in accordance with a measurement target wavelength band and measurement is executed.

### Configuration of Correction Operation Section and Outline of Correction Operation

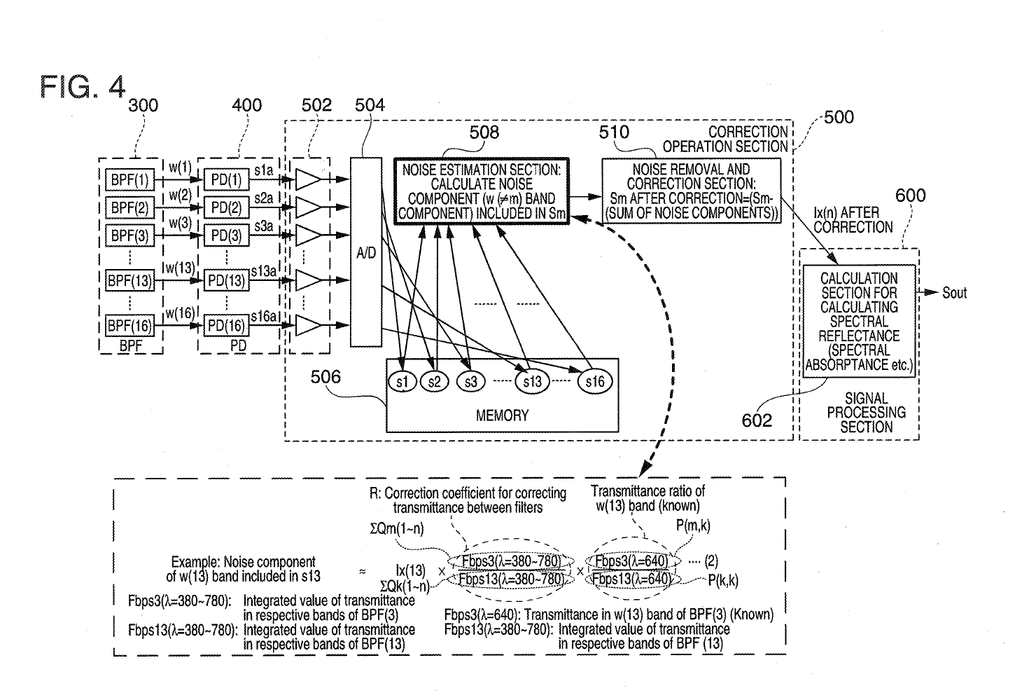

FIG. 4 is a diagram illustrating a configuration example of a correction calculation section and an outline of correction calculation. In FIG. 4, dispersed light components w(1) to w(16) are output from the first to 16th band-pass filters BPF(1) to BPF(16) included in the optical band-pass filter section 300. The first to 16th photodiodes PD(1) to PD(16) included in the light receiving section 400 receive the dispersed light components w(1) to w(16) and output electric signals (analog reception signals) S1a to S16a (the ending characteristics a represent that they are analog signals) corresponding to reception intensities through photoelectric conversion.

The correction operation section 500 includes, for example, an initial-stage amplifier 502 that amplifies the reception signal output from the light receiving section 400, an A/D converter 504 that converts the output signal (analog signal) of the initial-stage amplifier 502 into a digital signal, a memory 506 that can be used for storing various types of data, a noise estimation section 508 that estimates the amount of the noise components included in the reception data of the interest wavelength band, and a noise removal and correction section 510 that executes operation processing for removing noise.

The memory 506 temporarily stores the reception data (or reception light intensity data) S1 to S16 output from the A/D converter 504. The noise estimation section 508 estimates a noise component (a component having wavelengths in a wavelength band w (≠m)) included in the interest reception signal (interest reception data) Sm based on the reception data S1 to S16.

Moreover, the noise removal and correction section 510 subtracts the sum of noise components for each wavelength band from the interest reception signal (interest reception data) Sm to calculate a corrected reception signal (corrected reception data or corrected reception light intensity data).

Moreover, the signal processing section 600 includes a calculation section 602 for calculating a spectral reflectance, a spectral absorptance, or the like. The signal processing section 600 executes predetermined signal processing based on the corrected reception signal (corrected reception data) corrected by the correction operation section 500 to calculate a spectrophotometric distribution, for example.

### Outline of Estimation of Noise Components

First, as described above, among the plurality of wavelength bands (the first to n-th wavelengths), the m-th wavelength band (1≦m≦n) will be referred to as an interest wavelength band. The interest wavelength band is a wavelength band that is being focused on in the correction processing of the reception data. Moreover, the k-th wavelength band (k≠n and 1≦m≦n) other than the m-th wavelength band will be referred to as a non-interest wavelength band.

The light receiving section 400 shown in FIG. 4 receives the transmission light or the reflection light of the m-th band-pass filter PDm and outputs an interest reception signal Sm (any one of S1 to S16). Similarly, the light receiving section 400 receives the transmission light or reflection light of the k-th band-pass filter and outputs non-interest reception signals (signals excluding the interest reception signal Sm from S1 to S16) Sk.

Moreover, the transmittance or the reflectance in the k-th wavelength band of the m-th band-pass filter will be denoted as P(m,k), and the transmittance or the reflectance in the k-th wavelength band of the k-th band-pass filter will be denoted as P(k,k). Furthermore, the noise component for each wavelength band of the k-th wavelength band included in the interest reception signal Sm will be denoted as N(m,k).

Here, the noise estimation section 508 performs an operation based on Formula (1) below to estimate the amount of the noise components for each wavelength band of the k-th wavelength band included in the interest reception signal Sm.

N(m,k)=Sk·{P(m,k)/P(k,k)} (1)

Moreover, the noise removal and correction section 510 calculates the sum ΣN(m,k) of the estimated amount of noise components N(m,k) for each wavelength band. Moreover, the noise removal and correction section 510 performs an operation based on Formula (2) below to obtain a corrected reception signal (corrected reception data) Smc.

Smc=Sm−ΣN(m,k) (2)

In Formula (1) above (that is, N(m,k)=Sk·{P(m,k)/P(k,k)}), Sk is the non-interest reception signals obtained by the light receiving section receiving the transmission light or the reflection light of the k-th band-pass filter. The non-interest reception signals are all of the reception signals which are the entire output of the photodiodes and are known since they are actually measured. Here, although it is ideal to use only the value of a reception signal corresponding to light of the k-th wavelength band among the non-interest reception signals, since it is not possible to separate only the reception component corresponding to the light of the k-th wavelength band, all of the reception signals of the k-th band-pass filter are used as a substitute.

Moreover, P(m,k) is the transmittance or the reflectance in the k-th wavelength band of the m-th band-pass filter. The notation P(m,k) represents the transmittance (or the reflectance) P in the “k”-th wavelength band which is the non-interest wavelength band, of the “m”-th band-pass filter (an optical filter associated to the “m”-th wavelength band which is the interest wavelength). Moreover, the spectral properties (relative spectral intensities of the respective wavelengths) in all of the wavelength bands of the m-th band-pass filter are known.

Moreover, P(m,k) can be calculated by integrating the transmittance (reflectance) of the respective wavelengths included in the k-th wavelength band (that is, by calculating the entire area of the k-th wavelength band in a graph showing the relationship between wavelengths and transmittance (reflectance)). Therefore, P(m,k) is known.

Moreover, P(k,k) is the transmittance or the reflectance in the k-th wavelength band of the k-th band-pass filter. The notation P(k,k) represents the transmittance (or the reflectance) P in the “k”-th wavelength band which is the non-interest wavelength band, of the “k”-th band-pass filter (an optical filter associated to the “k”-th wavelength band which is the non-interest wavelength). Moreover, since the k-th band-pass filter is a filter associated to the k-th wavelength band, the transmittance in the k-th wavelength band is known.

The interest reception signal Sm is calculated using these known values. That is, the noise components N(m,k) for each wavelength band of the k-th wavelength band included in all of the reception signals obtained by the light receiving section receiving light from the m-th band-pass filter which is a filter associated to the interest wavelength band are calculated. The use of the expression “noise components N(m,k) for each wavelength band of the k-th wavelength band” is based on the following reason. As described above, the first to n-th wavelength bands are wavelength bands each having a predetermined wavelength width, and if n≧3, there will be two or more k-th wavelength bands which are the non-interest wavelength bands. Considering this, the expression expresses a case in which when there is a plurality of wavelength bands as the non-interest wavelength bands, the noise components for each wavelength band are calculated.

Here, it is possible to obtain the reception signal Sk corresponding to the transmittance (reflectance) P(k,k) in the k-th wavelength band of the k-th band-pass filter. That is, all of the reception signals can be as a substitute by regarded them as the reception signal corresponding to the k-th wavelength band. If P(k,k) is changed to P(m,k), since the amount of reception signals changes in accordance with the ratio between P(k,k) and P(m,k), the amount of reception signals will be changed to Sk·{P(m,k)/P(k,k)}. This amount of reception signal is regarded as the noise components N(m,k) for each wavelength band of the k-th wavelength band included in the interest reception signal Sm. Formula (1) above expresses this.

In this way, when the noise components are calculated for each non-interest wavelength band, the noise removal and correction section 510 calculates the sum ΣN(m,k) of the estimated noise components N(m,k) for each wavelength band. The notation ΣN(m,k) represents all of the signal components (that is, all of the noise components ΣN) of the “k”-th wavelength band which is the non-interest wavelength band, included in all of the reception signals obtained by the light receiving section receiving light from the “m”-th band-pass filter which is a filter associated to the interest wavelength band.

Moreover, the noise removal and correction section 510 executes an operation based on Formula (2) (namely, Smc=Sm−ΣN(m,k)) to obtain the corrected reception signal Smc. The corrected reception signal Smc is obtained by removing noise therefrom and can be regarded as substantially the reception signal (reception data) corresponding to light of the interest wavelength band. Thus, the measurement accuracy of the optical spectrum data is improved.

More preferably, the noise estimation section 508 performs an operation based on Formula (3) below to estimate the amount of the noise components for each wavelength band of the k-th wavelength band included in the interest reception signal Sm.

N(m,k)=Sk·{P(m,k)/P(k,k)}·R (3)

In Formula (3) above, ΣQm(1˜n) is the sum of the transmittance or the reflectance of all of the wavelength bands of the m-th band-pass filter, and ΣQk (1˜n) is the sum of the transmittance or the reflectance of all of the wavelength bands of the k-th band-pass filter. Moreover, R(=ΣQm(1˜n)/ΣQk(1˜n)) is a correction coefficient for correcting the difference (or the difference in the total light intensity) in the transmittance property or the reflectance property between the respective band-pass filters. When calculating the noise components, by using Formula (3) in place of Formula (1) described above, it is possible to further increase the accuracy of noise estimation.

In the operation based on Formula (1) described above, noise components are calculated based on a way of thinking in which “if P(k,k) is changed to P(m,k), since the amount of reception signals changes in accordance with the ratio between P(k,k) and P(m,k), the amount of reception signals will be changed to Sk·{P(m,k)/P(k,k)}”. However, actually, when an optical filter being used is switched from the k-th band-pass filter to the m-th band-pass filter, there is a difference in the total amount (total light intensity) of light entering the light receiving section after passing through the respective filters due to the different properties (for example, relative transmittance distribution or relative reflectance distribution) of the respective filters.

As described above, Sk used in Formula (1) above represents all of the reception signals of the light receiving section when the k-th band-pass filter is used. The noise components that are to be calculated are noise components included in all of the reception signals of the light receiving section when the m-th band-pass filter is used. That is, the noise components included in all of the reception signals when the m-th band-pass filter is used are estimated using actual measurement values when the k-th band-pass filter (a filter different from the m-th band-pass filter associated to correction) is used. At that time, there is a difference in the total amount (total light intensity) of light entering the light receiving section after passing through the respective filters due to the different properties (for example, relative transmittance distribution or relative reflectance distribution) of the respective filters. Therefore, by adding signal processing for compensating for the difference in the total light intensity resulting from the different properties of the respective filters when estimating noise, it is possible to further improve the measurement accuracy of the optical spectrum data.

Therefore, in the operation based on Formula (3) above, the operational formula of Formula (1) is multiplied by the correction coefficient R for correcting the difference in the transmittance property or the reflectance property between the filters.

Here, the sum of the transmittance or the reflectance of all of the wavelength bands of the m-th band-pass filter is denoted as ΣQm(1˜n), and the sum of the transmittance or the reflectance of all of the wavelength bands of the k-th band-pass filter is denoted as ΣQk(1˜n). When the k-th band-pass filter is switched to the m-th band-pass filter, the total amount of light entering the light receiving section will change in accordance with ΣQm(1˜n)/ΣQk(1˜n). Therefore, all of the reception signals Sk obtained from the light receiving section when the k-th band-pass filter is used will be corrected as Sk·{ΣQm(1˜n)/ΣQk(1˜n)} when the m-th band-pass filter is used.

The ratio (ΣQm(1˜n)/ΣQk(1˜n)) of the sum of transmittance properties and reflectance properties between the respective filters will be referred to as the correction coefficient R for correcting (compensating for) the difference in the transmittance properties or the reflectance properties between the respective filters. By multiplying the operational formula of Formula (1) above by the correction coefficient R, the difference in the transmittance properties or the reflectance properties between the respective filters is compensated. Accordingly, the measurement accuracy of the optical spectrum data is improved further.

A specific example of estimation of noise components is illustrated on the lower side of FIG. 4. In this example, it is assumed that a transmission-type optical band-pass filter is used as the optical band-pass filter section 300. Moreover, it is assumed that reception data S3 obtained by converting an analog reception signal S3a output from the third photodiode PD(3) into a digital value is used as an interest reception signal (interest reception data). In the reception data S3, noise components are superimposed for each wavelength band of w(1), w(2), and w(4) to w(16) which are non-interest wavelength bands. In the example of FIG. 4, it is assumed that the amount of the noise components in the 13th wavelength band (w(13)) is first estimated in accordance with Formula (3) described above.

The noise components in the 13th wavelength band (w(13)) included in the interest reception signal (interest reception data) S3 can be obtained by multiplying the non-interest reception signal (non-interest reception data) S13 by the transmittance (total light intensity) correction coefficient R between the third band-pass filter BPF(3) and the 13th band-pass filter BPF(13) and multiplying the same by the ratio (P(3,13)/P(13,13)) of the transmittances of the 13th wavelength band (w(13)) in the respective filters.

The correction coefficient R can be calculated by Fbps3(λ=380˜780)/Fbps13(λ=380˜780). Here, Fbps3(λ=380˜780) is an integrated value of the transmittances of the respective 16 wavelength bands in the third band-pass filter BPF(3). Moreover, Fbps13(λ=380˜780) is an integrated value of the transmittances of the respective 16 wavelength bands in the 13th band-pass filter BPF(13).

Moreover, Fbps3(λ=640) (=P(m,k)=P(3,13)) is a transmittance in the 13th wavelength band w(13) (central wavelength: 640 nm) of the third band-pass filter BPF(3). Furthermore, Fbps13(λ=640) (=P(k,k)=P(13,13)) is a transmittance in the 13th wavelength band w(13) (central wavelength: 640 nm) of the 13th band-pass filter BPF(13).

Since components (noise components) of unnecessary wavelength bands, which are superimposed on the reception data (reception light intensity data) are removed by such a correction operation, the accuracy of the reception data (reception light intensity data) is improved. Therefore, it is possible to improve the measurement accuracy of a spectral measurement device without using an optical band-pass filter which is expensive and large, for example.

### Second Embodiment

In the present embodiment, the configuration and operation of a colorimeter (color measurement device) to which the invention is applied will be described in detail by way of an example of a case in which the surface color of a sample is measured by a colorimeter (color measurement device) to which the invention is applied.

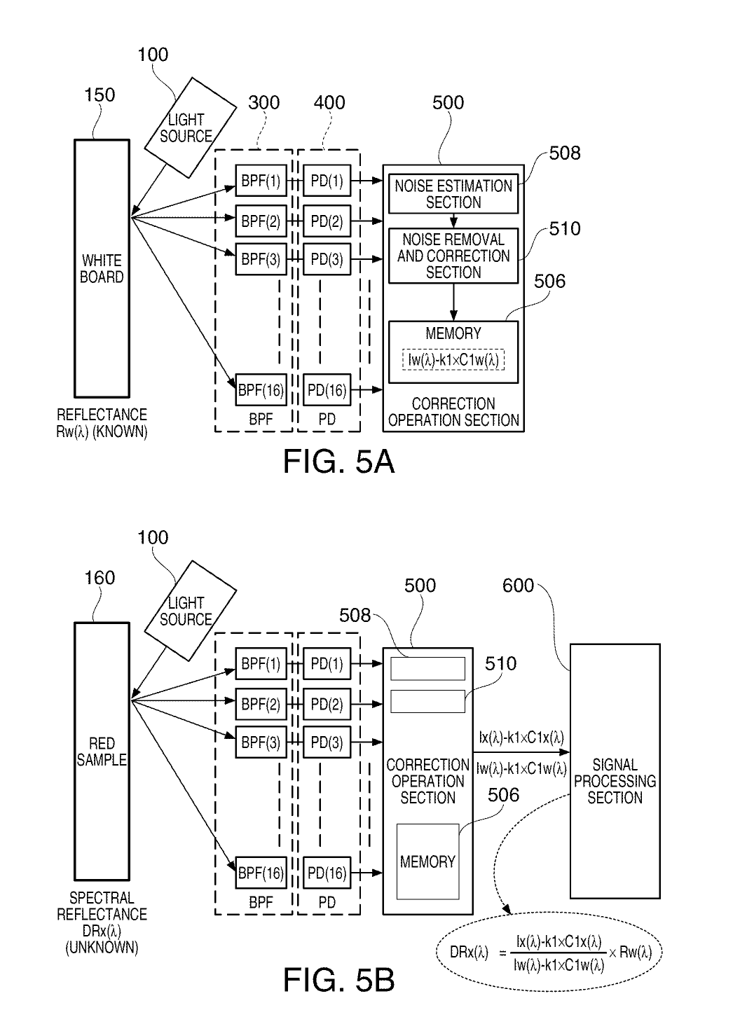

FIGS. 5A and 5B are diagrams showing an example of a measurement procedure when the surface color of a sample is measured by a colorimeter (color measurement device).

To measure the optical spectrum using a colorimeter (color measurement device), first, as shown in FIG. 5A, first measurement is executed using a white board 150 of which the spectral reflectance is known as a reference. Here, the known reflectance of the white board 150 is denoted as Rw(λ). Moreover, in this example, the reception data based on the reception signals obtained from the first to 16th photodiodes PD(1) to PD(16) are denoted as Iw(λ) [λ=400 nm, 420 nm, 440 nm, . . . , and 700 nm]. Here, λ represents the central wavelengths of the respective wavelength bands.

As described above, for example, the reception data Iw(λ=400 nm) corresponding to the first wavelength band obtained through actual measurement includes noise components corresponding to the respective bands of λ=420 nm, 440 nm, and 700 nm. Therefore, the noise estimation section 508 of the correction operation section 500 calculates the noise components for each wavelength band. The noise removal and correction section 510 calculates the sum of noise components of the respective wavelength bands. For example, the sum of noise components included in the reception data Iw(λ=400 nm) corresponding to the first wavelength band will be denoted as C1w(λ=400 nm). The noise removal and correction section 510 subtracts a product of the sum C1w(λ=400 nm) of the noise components and an adjustment correction coefficient k1 from Iw(λ=400 nm) to thereby obtain corrected reception data (corrected reception data of the first wavelength band) which are the reception data after correction. The value of the adjustment correction coefficient k1 can be appropriately set in accordance with the properties of a spectral measurement device (basically, k1=1). The corrected reception data (Iw(λ=400 nm)−k1/C1w(λ=400 nm)) are temporarily stored in the memory 506. After that, the same processing is executed, whereby the corrected reception data (corrected reception light intensity data) in each of the second to 16th wavelength bands are acquired, and the corrected reception data (corrected reception light intensity data) are temporarily stored in the memory 506.

Subsequently, as shown in FIG. 5B, the spectral reflectance of a sample 160 having a red surface is measured. In this example, the reception data based on the reception signals obtained from the first to 16th photodiodes PD(1) to PD(16) are denoted as Ix(λ) [λ=400 nm, 420 nm, 440 nm, . . . , and 700 nm].

Similarly to the case of the white board, the corrected reception data (Ix(λ=400 nm)−k1·C1x(λ=400 nm)) corresponding to the first wavelength band are temporarily stored in the memory 506. Similarly, the corrected reception data (corrected reception light intensity data) in each of the second to 16th wavelength bands are temporarily stored in the memory 506.

Subsequently, the signal processing section 600 calculates a spectral reflectance DRx(λ) for each wavelength band of the sample 160. The spectral reflectance DRx(λ) of the sample 160 can be calculated based on Formula (4) below.

DRx(λ)={Ix(λ)−k1·C1x(λ)}/{Iw(λ)−k1·C1w(λ)} [where, λ=400 nm, 420 nm, 440 nm, and 700 nm] (4)

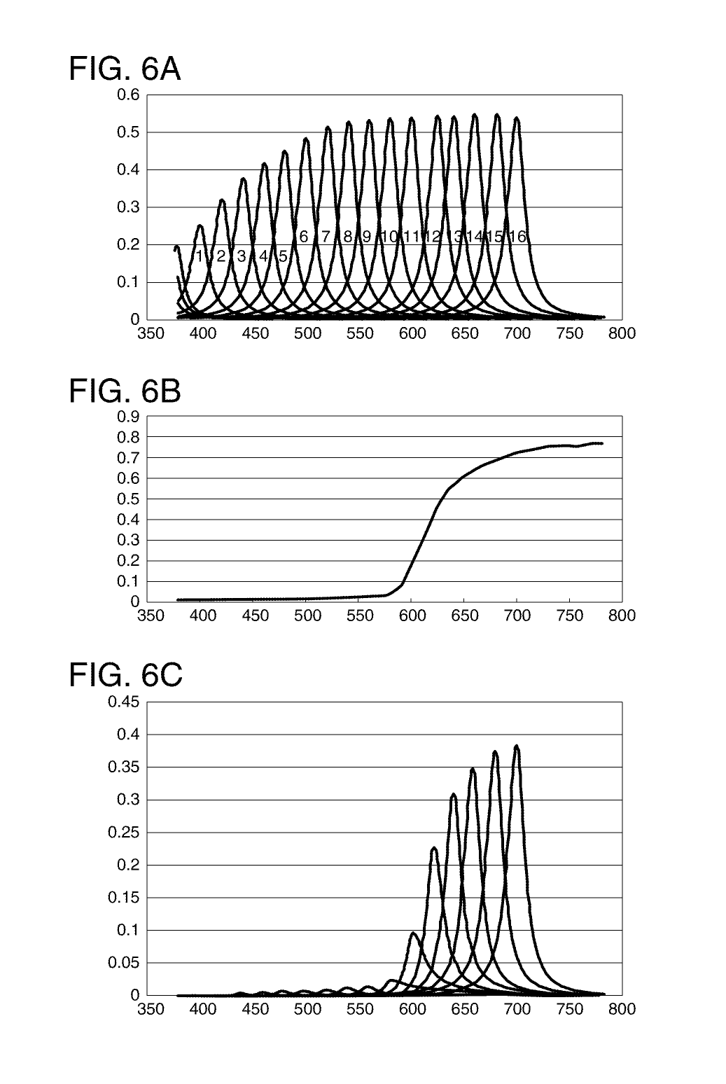

FIGS. 6A to 6C are diagrams showing an example of a spectral property of an optical band-pass filter, a reflectance property of a sample (red), and reception signal intensities in respective photodiodes, respectively. The spectral properties of the optical band-pass filter 300 in the colorimeter (color measurement device) shown in FIGS. 5A and 5B are as shown in FIG. 6A, for example.

Moreover, the reflectance properties of the sample (red) 160 are as shown in FIG. 6B. That is, although the relative reflectance in a wavelength band of 400 nm to 570 nm is low, the relative reflectance increases in a wavelength band of 580 nm to 780 nm.

The reception signal intensities of the respective photodiodes (PD(1) to PD(16)) corresponding to the respective wavelength bands are as shown in FIG. 6C, for example. The reception signal intensities can be calculated by multiplying the spectral properties in the respective wavelength bands of the optical band-pass filter 300 shown in FIG. 6A by the relative reflectance properties in the respective wavelength bands of the sample shown in FIG. 6B.

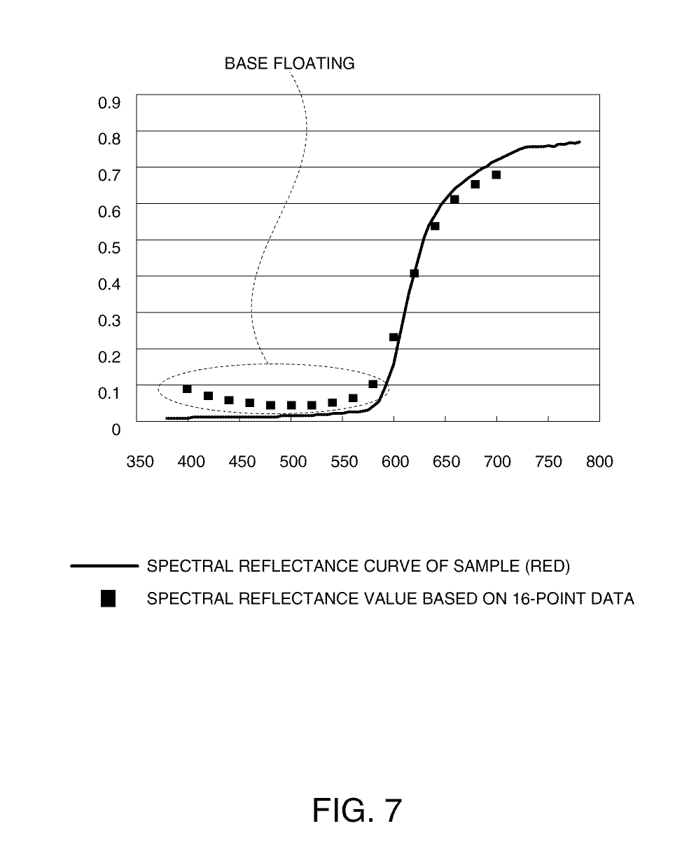

FIG. 7 is a diagram showing a difference between a spectral reflectance curve of a sample (red) and spectral reflectance values based on measured 16-point data (data which are not subjected to a correction process according to the invention). In FIG. 7, it can be understood that the difference between the actual measurement data and the spectral reflectances of an actual sample is particularly large in the vicinity of a wavelength band of 400 nm to 580 nm. As described above, since noise components of unnecessary wavelength bands are superimposed on the actual measurement data, the actual measurement value is larger than the spectral reflectance of an actual sample (that is, base floating occurs). The base floating decreases the measurement accuracy of the spectral reflectance.

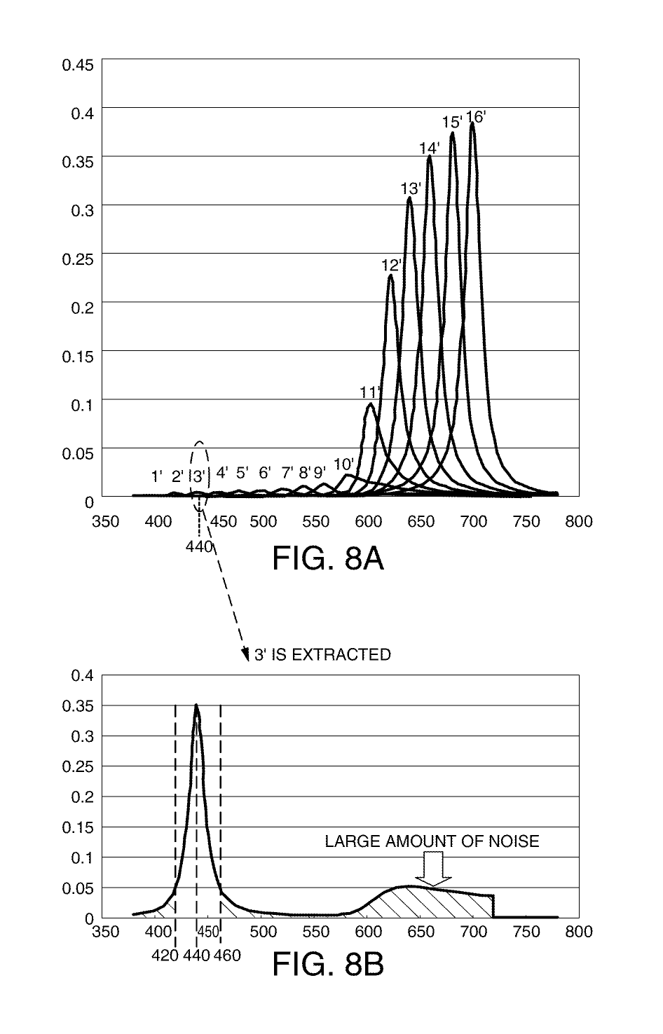

FIGS. 8A and 8B are diagrams showing the distribution of reception signal intensities (relative reception signal intensities) of respective photodiodes and showing the extracted optical spectra of a reception signal in a third wavelength band (a wavelength band having a central wavelength of 440 nm) in an enlarged scale, respectively. FIG. 8A shows the reception signal intensity distribution shown in FIG. 6C. The reception signals of each of the first to 16th photodiodes PD(1) to PD (16) are denoted as 1′, 2′, . . . , and 16′. As described above, the material color of the sample 160 is “red,” the reception signal intensities in the first to 10th wavelength bands are not higher than the reception signal intensities in the 11th to 16th wavelength bands. Therefore, large noise components are superimposed on the first to 10th wavelength bands to cause base floating. Thus, the S/N ratio of the reception signals in these respective wavelength bands decreases greatly.

FIG. 8B shows the extracted optical spectra of the reception signal 3′ in the third wavelength band in an enlarged scale. Since the half bandwidth of the third band-pass filter BPF(3) is broad, the components of the respective first, second, and fourth to 16th wavelength bands in addition to the wavelength components of the third wavelength band which is the original wavelength band are superimposed on the reception signal 3′. Since the material color (surface color) of the sample 160 is red, large noise components (unnecessary components) appear in the vicinity of a wavelength band of 600 nm to 720 nm.

Therefore, in the present embodiment, data processing (correction processing) for removing the unnecessary wavelength components (noise components) is executed on the reception data (reception light intensity data). In this way, most of the noise components superimposed on the reception signal 3′ in the third wavelength band are removed, and the accuracy of the measurement signals in the third wavelength band is improved. The same correction processing is executed on the other wavelength bands (particularly, a wavelength band of 600 nm or lower in which base floating is likely to occur). In this way, the accuracy of the measurement data is improved.

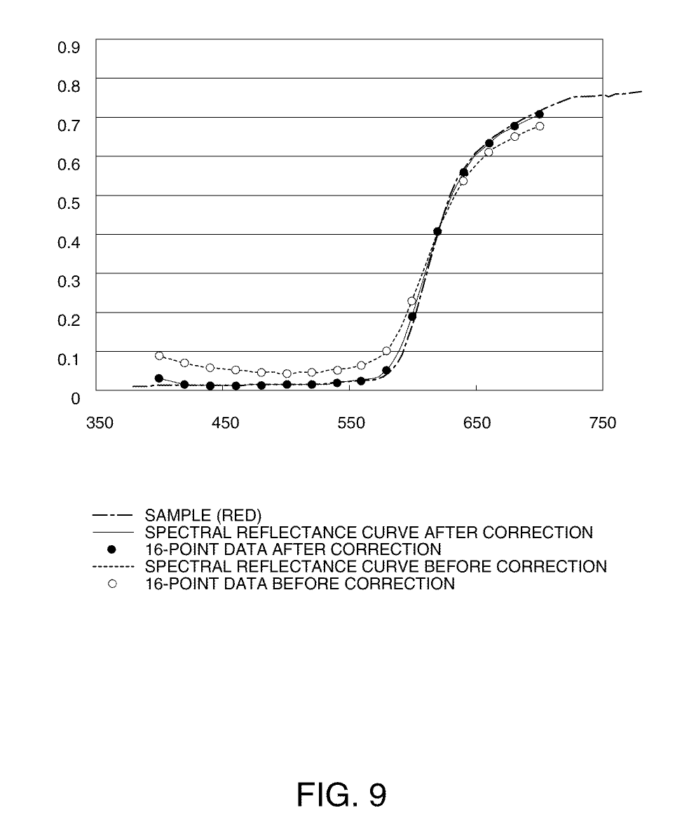

FIG. 9 is a diagram showing, for comparison purpose, a spectral reflectance curve generated based on measurement data (16-point data) before correction and a spectral reflectance curve generated based on measurement data (16-point data) after correction. In FIG. 9, the spectral reflectance curve of the original color of the sample (red) 160 is indicated by one-dot chain line. Moreover, white circles represent the measurement data (16-point data) before correction. Furthermore, a dotted line represents the spectral reflectance curve generated based on the measurement data (16-point data) before correction. Furthermore, black circles represent the measurement data (16-point data) after correction. Furthermore, a solid line represents the spectral reflectance curve generated based on the measurement data (16-point data) after correction.

As will be clear from FIG. 9, in the spectral reflectance curve (dotted line) based on the measurement data (16-point data) before correction, base floating occurs in a wavelength band of 600 nm or lower. In contrast, the spectral reflectance curve (solid line) based on the measurement data (16-point data) after correction approximately overlaps with the spectral reflectance curve (one-dot chain line) of the original color of the sample (red) 160. That is, the accuracy of the measurement data is improved by the correction processing.

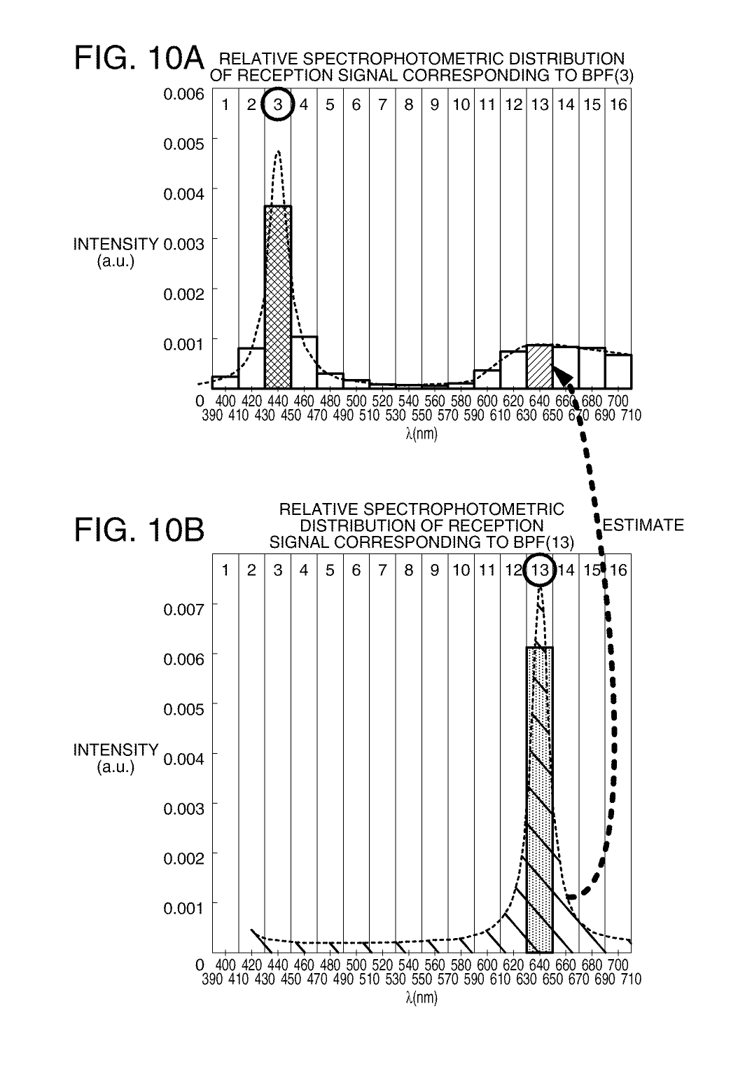

Next, correction of data in a colorimeter (color measurement device) will be described in detail with reference to FIGS. 10A to 15B. FIGS. 10A and 10B are diagrams illustrating an outline of an estimation method of noise components in a 13-th wavelength band, which are included in the light of a third wavelength band passed through a third band-pass filter.

For example, although the third band-pass filter BPF(3) is an optical filter associated to a wavelength band having a width of 20 nm and a central wavelength of 440 nm, as described above, since the actual reception signal of the third photodiode (third photoreceiver PD(3)) includes the components (noise components) of the other wavelength bands (the first, second, and fourth to 16th wavelength bands). In order to correct the reception data, it is necessary to estimate the signal amount of the noise components in the respective wavelength bands.

In FIG. 10A, a wavelength band having a central wavelength of 440 nm indicated by a reticular pattern is the original wavelength associated to the third band-pass filter BPF(3). In this example, a case of estimating the amount of the noise components indicated by hatching among the noise components (FIG. 10A) of the 13th wavelength band will be described as an example.

In estimation of the amount of the noise components of the 13th wavelength band, some basic data are required. As the basic data, the reception data obtained by the 13th photodiode PD(13) receiving light having passed through the 13th band-pass filter BPF(13) are used. It may be ideal to use only the reception data of the 13th wavelength band indicated by a dotted pattern in FIG. 10B as the basic data. However, since it is not possible to know only the amount of reception signal of the 13th wavelength band among all of the reception signals of the 13th photodiode PD(3), all of the reception signals obtained from the 13th photodiode PD(3) (that is, the reception data indicated by hatching in FIG. 10B) are used (substituted) in place of the reception data of the 13th wavelength band.

The reception signal intensity of the 13th wavelength band corresponding to the third photodiode PD(3) shown in FIG. 10A is lower than the reception signal intensity of the 13th wavelength band corresponding to the 13th photodiode PD(13) shown in FIG. 10B. However, this is because the transmittance of the third band-pass filter BPF(3) in the 13th wavelength band is different from the transmittance of the 13th band-pass filter BPF(13) in the 13th wavelength band. If the difference in the transmittance between the respective filters is known, by multiplying the reception signal intensity (substituted by entire reception data) of the 13th wavelength band corresponding to the 13th photodiode PD(13) by the ratio of transmittance between the respective filters in the 13th wavelength band, it is possible to estimate the amount of the noise components (the reception signal intensity of the 13th wavelength band corresponding to the third photodiode PD(3)).

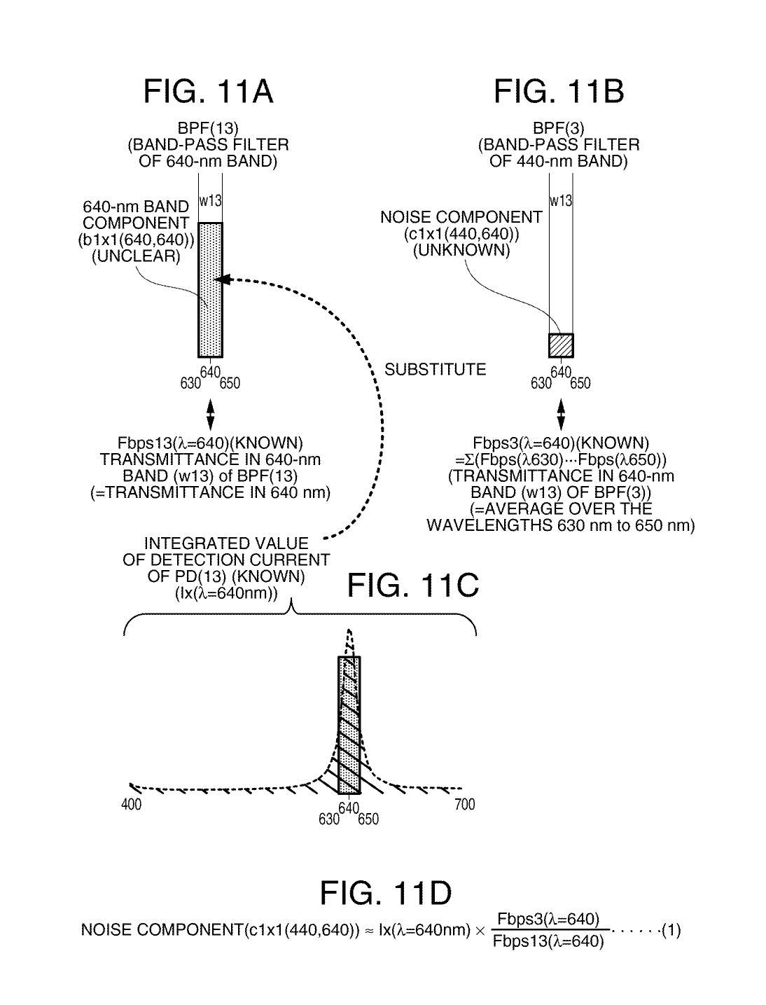

FIGS. 11A to 11D are diagrams showing a first specific example (correction using Operational Formula (1)) of a method of estimating the amount of the noise components. In FIG. 11A, signal components indicated by a dotted pattern are reception signal components (unclear) in the 640-nm band (the 13th wavelength band w(13)) of the 13th band-pass filter BPF(13) (a band-pass filter associated to the 640-nm band). In place of the reception signal components, all of the reception signals Ix(λ=640 nm) of the 13th photodiode PD(13) shown in FIG. 11C are substituted. All of the reception signals Ix(λ=640 nm) of the 13th photodiode PD (13) are the integrated value of detection current for each wavelength of the 13th photodiode PD(13). All of the reception signals are known since they are actually measured.

Moreover, the transmittance (Fbps13(λ=640) in the 640-nm band (the 13th wavelength band w(13)) of the 13th band-pass filter BPF (13) is known. That is, the transmittance property is already known since the transmittance is the transmittance of the original band of the 13th band-pass filter BPF(13).

Moreover, in FIG. 11B, signal components indicated by hatching are noise components which are to be estimated. The noise components are reception signal components (unknown) in the 440-nm band (the 13th wavelength band w(13)) of the third band-pass filter BPF(3) (a band-pass filter associated to the 440-nm band). In the drawing, the noise components are denoted as c1x1(440,640). This notation represents the noise components c1x1 in the 640-nm band of a band-pass filter associated to the 440-nm band.

However, the transmittance (Fbps3(λ=640) in the 640-nm band (the 13th wavelength band w(13)) of the third band-pass filter BPF(3) is known. That is, Fbps3(λ=640) can be calculated by integrating the transmittances Fbps(λ630) to Fbps(λ650) in the respective wavelength bands of 630 nm to 650 nm of the third band-pass filter BPF(3) and then averaging the integrated value.

FIG. 11D shows the specific content of the correction operational formula (Formula (1)) described above. That is, specifically, Formula (1) can be expressed as follows.

Noise Component c1x1(440,640)≈Ix(λ=640 nm)×Fbps(λ=640)/Fbps13(λ=640) (1)

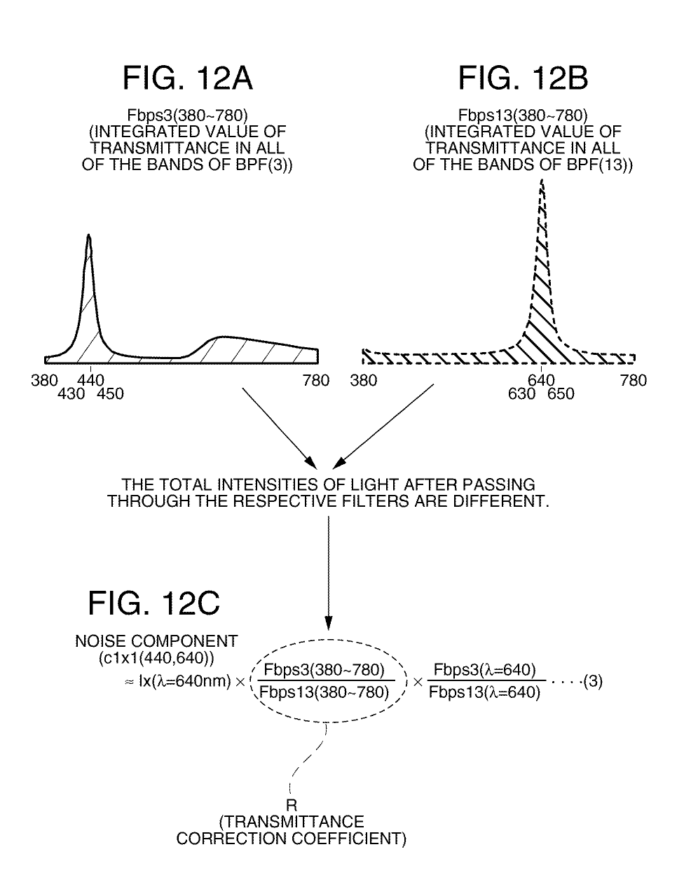

FIGS. 12A to 12C are diagrams showing a second specific example (correction using Operational Formula (3)) of a method of estimating the amount of the noise components. In Formula (1) described above, the difference in transmittance (difference in total light intensity) between the filters is not taken into consideration. Therefore, in the example shown in FIGS. 12A to 12C, the basic data serving as the basis of noise estimation are corrected using the correction coefficient (transmittance correction coefficient) R for correcting the difference in transmittance (difference in total light intensity) between the filters.

“Fbps3(380˜780)” shown in FIG. 12A is an integrated value of the transmittances in the respective 16 wavelength bands w(1) to w(16) of the third band-pass filter BPF(3). Similarly, “Fbps13(380˜780)” shown in FIG. 12B is an integrated value of the transmittances in the respective 16 wavelength bands w(1) to w(16) of the 13th band-pass filter BPF(13).

“Fbps3 (380˜780)” corresponds to an integrated value of detection current for each wavelength of the third photodiode PD(3); that is, it corresponds to the total area of a closed figure determined by an optical spectrum distribution curve. Moreover, “Fbps13(380˜780)” corresponds to an integrated value of detection current for each wavelength of the 13th photodiode PD(13); that is, it corresponds to the total area of a closed figure determined by an optical spectrum distribution curve. By comparing the area of a closed figure shown in FIG. 12A and the area of a closed figure shown in FIG. 12B, it is possible to know that the two areas are different (this results from a difference in optical spectrum properties). That is, the total intensities of light after passing through the respective band-pass filters are different.

Therefore, in the operation based on Formula (3), the basic data Ix(λ=640 nm) serving as the basis of noise estimation are corrected considering the difference in transmittance (difference in total light intensity) between the filters. That is, as shown in FIG. 12C, all of the reception signals Ix(λ=640 nm) are multiplied by the correction coefficient R (transmittance correction coefficient) representing the ratio of transmittances in all of the wavelength bands of the respective filters, and all of the reception signals Ix(λ=640 nm) of the 13th photodiode PD(13) are corrected so as to correspond to the properties of the third band-pass filter BPF(3). The data obtained through correction are used as the basic data for noise estimation, and the corrected basic data are multiplied by the ratio (Fbps(λ=640)/Fbps13(λ=640)) of transmittances in the 13th wavelength band of the respective filters to thereby calculate the noise component c1x1(440,640) of the 13th wavelength band included in the reception signal (third reception data) of the third photodiode PD(3). This is the content of Formula (3) shown in FIG. 12C. According to Formula (3), since the basic data are corrected considering the difference in optical properties (transmittance or reflectance) between the filters, the measurement accuracy is further improved.

After that, the amounts of the noise components in the respective first, second, fourth to 12th, and 14th to 16th wavelength bands included in the reception signal (third reception data) obtained from the third photodiode PD(3) are estimated by the same method (correction operation based on Formula (1) or (3)). The estimated noise data of the respective wavelength bands are temporarily stored in the memory 506.

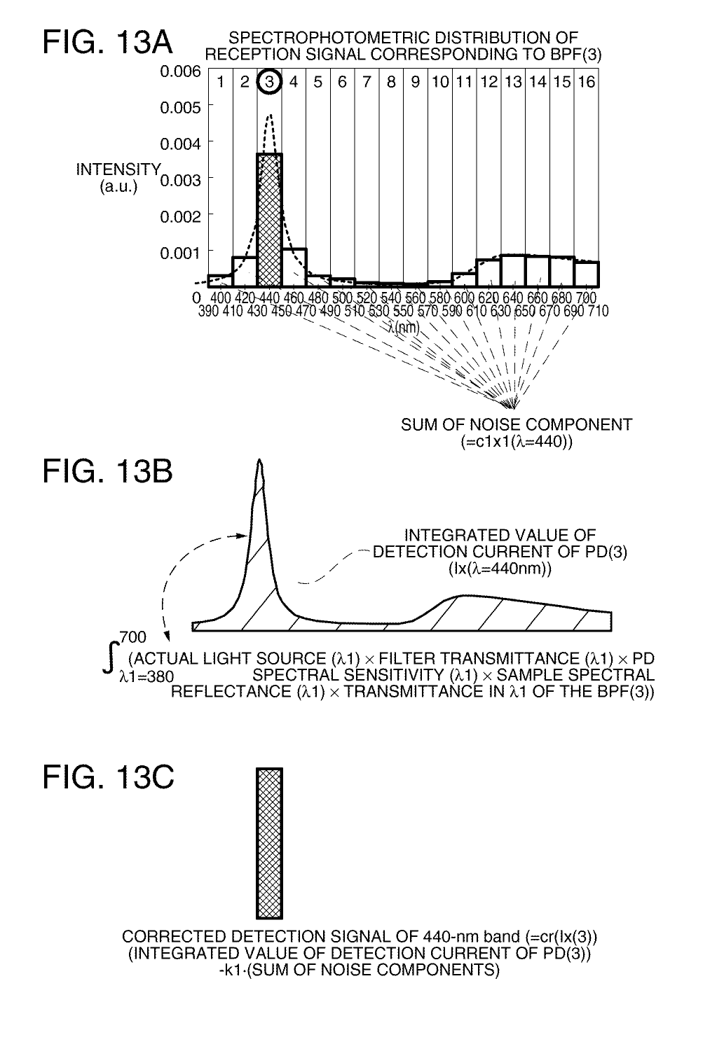

FIGS. 13A to 13C are diagrams illustrating the content of noise removal and correction by a noise removal and correction section 510. As shown in FIG. 13A, the noise removal and correction section 510 calculates the third reception data corresponding to the third band-pass filter BPF(3). That is, the noise removal and correction section 510 calculates the sum (c1x1(440)) of noise components included in the reception data obtained from the third photodiode PD(3). Here, the notation c1x1(440) represents all of the noise components c1x1 included in the reception data of the 440-nm band.

FIG. 13B shows all of the reception signals (the integrated value of detection current for each wavelength) Ix(λ=640 nm) of the 13th photodiode. All of the reception signals Ix(λ=640 nm) can be calculated accurately by a mathematical formula. That is, when λ1 is used as a parameter representing the wavelength of light, Ix(λ=640 nm) can be calculated by integrating the products of an actual light source (λ1), a filter transmittance (λ1), a PD spectral sensitivity (λ1), a sample spectral reflectance (λ1), and a transmittance in λ1 of the BPF(3) over a range of λ1 from 380 to 700.

The noise removal and correction section 506 subtracts the calculated sum (c1x1(440)) of the noise components from all of the reception signals (integrated value of detection current for each wavelength) Ix(λ=640 nm) of the 13th photodiode (this subtraction corresponds to an operation based on Formula (2) above). In this way, as shown in FIG. 13C, it is possible to obtain a detection signal (the third reception data after correction) of the 440-nm band in which noise components are greatly suppressed. The same correction processing is executed for the reception data of the other wavelength bands.

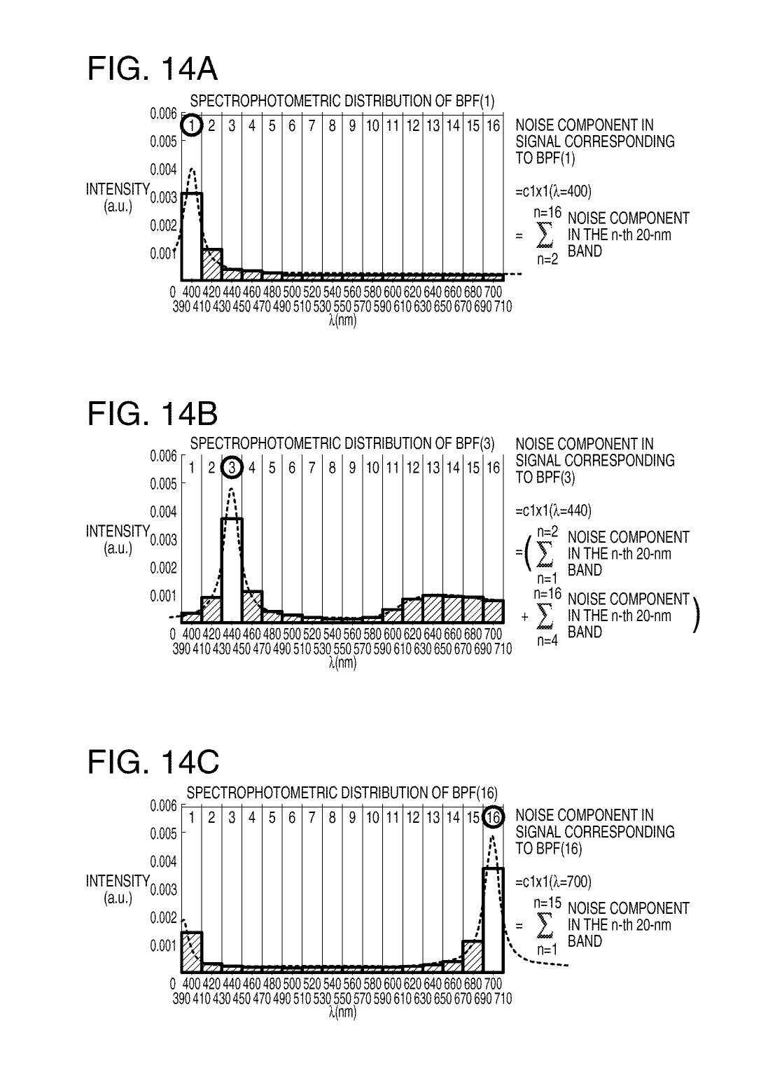

FIGS. 14A to 14C are diagrams showing an example of a method of calculating the sum of noise components. When there are the first to n-th wavelengths (n is an integer of 2 or more, and in this example, n=16) having a predetermined wavelength width (in this example, width=20 nm) as a spectral band, three methods shown in FIGS. 14A to 14C can be considered as a method of calculating the sum of the noise components included in the m-th reception data which are the interest reception data (here, the sum corresponds to the sum of the noise components in the k-th wavelength band (k≠m and 1≦k≦n) which is the non-interest wavelength).

In the case of FIG. 14A, the first wavelength band is the interest wavelength band, and the second to 16th wavelength bands are the non-interest wavelength bands. Therefore, the sum c1x1(λ=400) of noise components can be calculated by summing the noise components in the respective second to 16th wavelength bands.

In the case of FIG. 14B, the third wavelength band is the interest wavelength band, for example, and the respective first, second, and fourth to 16th wavelength bands are the non-interest wavelength bands. Therefore, the sum c1x1(λ=440) of noise components can be calculated by adding the sum of the noise components in the respective first and second wavelength bands and the sum of the noise components in the respective fourth to 16th wavelength bands.

In the case of FIG. 14C, the 16th wavelength band is the interest wavelength band, and the first to 15th wavelength bands are the non-interest wavelength bands. Therefore, the sum c1x1(λ=700) of noise components can be calculated by summing the noise components in the respective first to 15th wavelength bands.

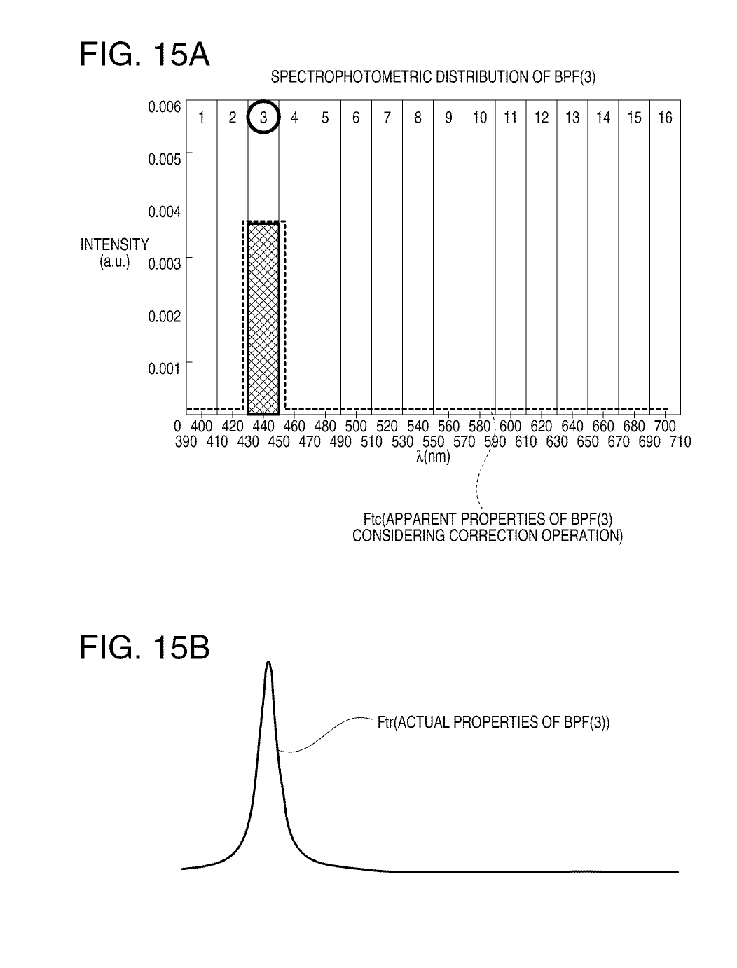

FIGS. 15A and 15B are diagrams showing a difference in the band-pass filter properties depending on presence of a correction process. As shown in FIG. 15B, the actual spectral property Ftr of the optical band-pass filter section 300 has a property such that it has a portion with broad skirts. However, when the reception data are corrected so as to suppress noise, the spectral property Ftc of the optical band-pass filter section 300 is changed to a steep band-pass property as shown in FIG. 15A. Therefore, it is possible to improve the measurement accuracy of the spectral measurement device while allowing the use of various optical filters. For example, high-accuracy spectral measurement can be performed using a simple and cheap wavelength band-pass filter such as a variable-gap etalon.

As described above, by suppressing an increase of noise resulting from an overlap of transmission wavelength bands (reflection wavelength bands) of a plurality of optical band-pass filters through a correction operation using the reception signals of wavelength bands (non-interest wavelength bands) other than a target wavelength band (interest wavelength band), it is possible to improve the measurement accuracy of the spectral measurement device without using an expensive optical band-pass filter, for example.

For example, cost reduction of a filter device can be achieved by using simple filters. Moreover, it is possible to achieve cost reduction, miniaturization, and weight reduction by using a variable interference filter.

Although some embodiments of the invention have been described above in detail, those skilled in the art will readily understand that various modifications may be made without substantially departing from the new items and the effects of the invention. Therefore, such modifications are entirely included within the scope of the invention. For example, any term described at least once together with a broader or synonymous different term in the specification or the drawing may be replaced by the different term at any place in the specification or the drawings. For example, even when two or more optical low-pass filters or two or more optical high-pass filters are used in place of the optical band-pass filter, the invention can be applied if the wavelengths of the transmission light (reflection light) overlap with each other.

Moreover, although in the embodiments described above, the spectral reflectance of a sample was used, the same problem occurs when spectral measurement is performed using an optical filter having a broad half bandwidth, for example, by calculating the transmittance or absorptance of a sample. Therefore, the invention can be applied to a case of calculating the spectral transmittance and the spectral absorptance of a sample. For example, a relation of (Reflectance)+(Absorptance)=1 and a relation of (Transmittance)+(Absorptance)=1 are satisfied. Therefore, the relations can be expressed as Absorptance=1−(Reflectance) and Transmittance=1−(Absorptance). Thus, if the spectral reflectance of a sample is known, the spectral absorptance and the spectral transmittance of the sample can be measured in accordance with the formulas above.

The invention can be broadly applied to spectral measurement devices such as a colorimeter, a spectroscopic analyzer, and a spectrum analyzer.

The entire disclosure of Japanese Patent Application No. 2010-125717, filed Jun. 1, 2010 is expressly incorporated by reference herein.

What is claimed is:

1. A spectral measurement device comprising:
an optical band-pass filter section that has first to n-th wavelengths (n is an integer of 2 or more) having a predetermined wavelength width as a spectral band thereof;
a light receiving section that receives light from the optical band-pass filter section;
a correction operation section that performs an operation to correct a reception signal obtained from the light receiving section; and
a signal processing section that executes predetermined signal processing based on the reception signal corrected by the correction operation section,
wherein when, among the first to n-th wavelengths, an m-th wavelength band (1≦m≦n) is an interest wavelength band, and a k-th wavelength band (k≠m and 1≦k≦n) other than the m-th wavelength band is a non-interest wavelength band, the optical band-pass filter section functions as an m-th band-pass filter corresponding to the m-th wavelength band and also functions as a k-th band-pass filter corresponding to the k-th wavelength band, and
wherein the correction operation section includes
a noise estimation section that estimates the amount of the noise component for each wavelength band of the k-th wavelength band included in an interest reception signal obtained by the light receiving section receiving transmission light or reflection light of the m-th band-pass filter corresponding to the m-th wavelength band, and
a noise removal and correction section that performs correction of subtracting the sum of the estimated noise component for each wavelength band from the interest reception signal to thereby calculate a corrected reception signal.

2. The spectral measurement device according to claim 1,
wherein when the interest reception signal obtained by the light receiving section receiving the transmission light or reflection light of the m-th band-pass filter is Sm,
a non-interest reception signal obtained by the light receiving section receiving the transmission light or reflection light of the k-th band-pass filter is Sk,
a transmittance or a reflectance in the k-th wavelength band of the m-th band-pass filter is P(m,k),
a transmittance or a reflectance in the k-th wavelength band of the k-th band-pass filter is P(k,k), and
a noise component for each wavelength band of the k-th wavelength band included in the interest reception signal sm is N(m,k),
the noise estimation section performs an operation based on Formula (1) below to estimate the amount of the noise component for each wavelength band of the k-th wavelength band included in the interest reception signal Sm, and
N(m,k)=Sk·{P(m,k)/P(k,k)} (1)
the noise removal and correction section calculates the sum ΣN(m,k) of the estimated noise component N(m,k) for each wavelength band and executes an operation based on Formula (2) below to obtain the corrected reception signal Smc
Smc=Sm−ΣN(m,k) (2).

3. The spectral measurement device according to claim 2,
wherein when the sum of transmittance or reflectance of all wavelength bands of the m-th band-pass filter is ΣQm(1˜n),
the sum of transmittance or reflectance of all wavelength bands of the k-th band-pass filter is ΣQk(1˜n), and
a correction coefficient for correcting a difference in the transmittance properties or reflectance properties between filters is R (=ΣQm(1˜n)/ΣQk(1˜n)),
the noise estimation section performs an operation based on Formula (3) below to estimate the amount of the noise component for each wavelength band of the k-th wavelength band included in the interest reception signal Sm
N(m,k)=Sk·{P(m,k)/P(k,k)}·R (3).

4. The spectral measurement device according to claim 1,
wherein the optical band-pass filter section is formed of a variable wavelength filter, and the properties of the variable wavelength filter are variably controlled whereby the band-pass properties of the m-th band-pass filter and the k-th band-pass filter are realized.

5. The spectral measurement device according to claim 4,
wherein the optical band-pass filter section is a variable gap-type etalon filter.

6. The spectral measurement device according to claim 1,
wherein the signal processing section measures a spectrophotometric distribution of the sample based on the corrected reception signal.
